(19) United States
(12) Patent Application Publication
(10) Pub. No.: US 2026/0172400 A1
(43) Pub. Date: Jun. 18, 2026

(54) BACK-UP CONNECTIONS FOR A RESIDENTIAL GATEWAY

(71) Applicant: AT&T Intellectual Property I, L.P., Atlanta, GA (US)

(72) Inventors: Virginia Seid Ng, Lawrenceville, GA (US); Michael R. Albrecht, Dallas, TX (US); Hessam Moeini, Frisco, TX (US)

(21) Appl. No.: 18/979,577

(22) Filed: Dec. 12, 2024

(51) Int. Cl. H04L 9/40

(52) U.S. Cl. CPC H04L 63/0428

(57) ABSTRACT

Methods and apparatuses for automatically providing a back-up connection for a residential gateway are disclosed. An example method includes detecting that a wireline connection for access to a communication network at a location is malfunctioning, establishing a virtual private network tunnel with a first endpoint device at the location via a local network connection, receiving a data packet from a second endpoint device at the location, encrypting the data packet, and transmitting the data packet that is encrypted over the virtual private network tunnel to the first endpoint device, wherein the first endpoint device is to transmit the data packet that is encrypted to a destination over a cellular connection of the first endpoint device.

The present disclosure relates generally to access technologies, and relates more particularly to devices, non-transitory computer-readable media, and methods for providing a back-up connection for residential gateways.

### BACKGROUND

When devices such as video streaming devices, Internet of Things (IOT) devices, gaming consoles, etc. are connected to an existing residential gateway (RG) through Ethernet or Wi-Fi, these devices normally submit their requests to and receive responses from the RG which is connected to e.g., a wireline network. However, these devices may become disconnected from the Internet if the residential gateway loses connectivity to the wireline network for some reason. Depending on the cause, an interruption might be brief or last several hours, and from a network operator perspective, this event could be either planned or unplanned.

### SUMMARY

Methods and apparatuses for automatically providing a back-up connection for a residential gateway are disclosed. An example method includes detecting that a wireline connection for access to a communication network at a location is malfunctioning, establishing a virtual private network tunnel with a first endpoint device at the location via a local network connection, receiving a data packet from a second endpoint device at the location, encrypting the data packet, and transmitting the data packet that is encrypted over the virtual private network tunnel to the first endpoint device, wherein the first endpoint device is to transmit the data packet that is encrypted to a destination over a cellular connection of the first endpoint device.

In another example, an apparatus includes a processor and a non-transitory computer-readable medium. The non-transitory computer-readable medium stores instructions which, when executed by the processor, cause the processor to perform operations. The operations include detecting that a wireline connection for access to a communication network at a location is malfunctioning, establishing a virtual private network tunnel with a first endpoint device at the location via a local network connection, receiving a data packet from a second endpoint device at the location, encrypting the data packet, and transmitting the data packet that is encrypted over the virtual private network tunnel to the first endpoint device, wherein the first endpoint device is to transmit the data packet that is encrypted to a destination over a cellular connection of the first endpoint device.

In another example, a method is executed by a processor of an application server of a service provider network. The method includes receiving a notification signal from a residential gateway at a location indicating that a back-up connection is to be established with a first endpoint device at the location based on a detection that a wireline connection for access to the service provider network at the location is malfunctioning, receiving a request from the first endpoint device at the location to establish a virtual private network tunnel, authorizing the first endpoint device at the location to establish the virtual private network over a local network connection with the residential gateway, and receiving a data packet via the virtual private network tunnel between the residential gateway and the first endpoint device and a cellular connection of the first endpoint device.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for automatically providing a back-up connection for a residential gateway may operate;

FIG. 2 illustrates an example block diagram of a portion of the network of the present disclosure;

FIG. 3 illustrates an example timing diagram of the present disclosure;

FIG. 4 illustrates a flowchart of an example method for automatically providing a back-up connection for a residential gateway from the perspective of the residential gateway, in accordance with the present disclosure;

FIG. 5 illustrates a flowchart of an example method for automatically providing a back-up connection for a residential gateway from the perspective of the network; and

FIG. 6 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for automatically providing a back-up connection for a residential gateway. As discussed above, various devices may become disconnected from the Internet if the residential gateway loses connectivity to the wireline network for some reasons. Depending on the cause, an interruption might be brief or lasting several hours, and from a network operator perspective, it could be either planned or unplanned.

When a wireline-based Internet customer loses connectivity over fiber, it is desirable that the customer would not lose connectivity completely. The present disclosure provides a solution that would be able to switch connectivity methods from wireline to wireless seamlessly, without physical intervention by the user, and without requiring the residential gateway to include a dedicated cellular modem. Although other solutions may exist that require a customer having to activate a hotspot functionality on a user device, to configure the router and/or router application for such use, and then to connect to such established hotspot functionality, such solutions are cumbersome and require a substantial amount of user involvement.

Examples of the present disclosure provide a system that automatically provides a back-up connection for a residential gateway. RGs have a last breath functionality that can send a notification to an operations support system when RGs have lost connectivity. Instead of having a customer switch the user endpoint's (UE's) Wi-Fi off to enable its hotspot functionality (since the Wi-Fi and hotspot functionality may both utilize the same frequency bands and UE cannot have both functionalities on simultaneously) to act as the new access point which may let the RG connect to an external network to gain access to the Internet, the present disclosure retains the already established Wi-Fi connection between the UE and RG and uses a Virtual Private Network (VPN) to create a tunnel between the RG and a pre-implemented cloud-based gateway, which, in this case, interfaces with the external networks and to the Internet. The UE uses its Wi-Fi modem to connect to the RG as one end of the VPN tunnel and also uses its cellular interface to connect to the other end of tunnel, via the cloud GW.

When the RG detects a failure, it will initiate a listener service for network requests. The operations support system then notifies a pre-configured mobile UE to initiate a network connection to the residential gateway through the existing Wi-Fi connection, and a network connection to an application server (AS) in the cloud through its cellular connection. When the RG receives a network connect request from a second UE, the RG will encrypt and transmit the outbound data packets to the pre-configured mobile UE instead of to the wireline connection. When the pre-configured mobile UE receives the data packets from the RG, the pre-configured mobile UE will forward those packets to the AS without inspecting or decrypting the packets, thereby assisting the RG to send the data packets to the cloud application. The AS will then decrypt the packets and transmit them across the internet to the cloud application, which would handle the data packets as if the data packets had originated from the wireline network. The application server will also handle the data packets that are inbound to the RG in a similar manner: encrypting them, sending them to the pre-configured UE, which forwards them to the RG where they are decrypted and routed to the second (originating) UE.

As an enhancement, the present disclosure can also support the definition and use of multiple UEs as backup devices, enabling a higher overall throughput, a more reliable connection, and minimizing any disruption should one or more of the pre-configured mobile UEs leave the premises.

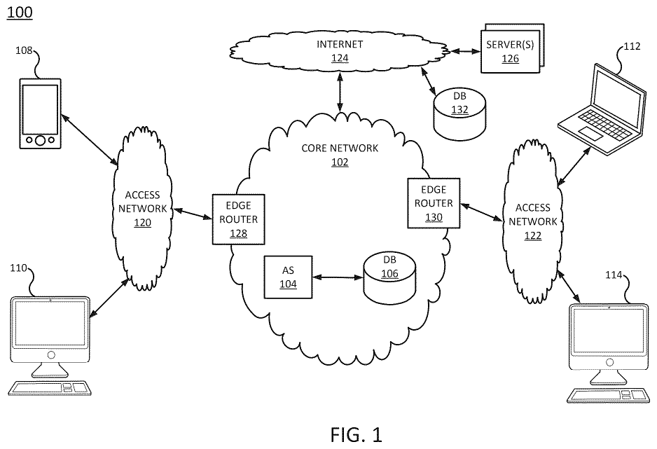

The present disclosure can also detect anomalies and prevent misbehaviors that could cause congestion on the mobility network. For example, UE Route Selection Policy (URSP) can be used to control the outgoing traffic on the backed-up UE(s). Data Network Name (DNN) can also be utilized for 5G or Access Point Name (APN) for LTE to distinguish the traffic, allowing the option of implementing alternate charging rates and/or changes to the traffic treatment for the data used by this solution. These and other aspects of the present disclosure are discussed in greater detail below in connection with the examples of FIGS. 1-6.

To further aid in understanding the present disclosure, FIG. 1 illustrates an example system 100 in which examples of the present disclosure for automatically providing a back-up connection for a residential gateway may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, or any future generation of wireless technology such as 6G, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. For example, the operator of the core network 102 may provide a cable television service, an IPTV service, media streaming service, or any other types of communication services to subscribers via access network 120 or access network 122. In one example, the core network 102 may be operated by a telecommunication network service provider. The core network 102 and the access networks 120 and 122 may be operated by different service providers, the same service provider or a combination thereof, or the access networks 120 and 122 may be operated by an entity having a core business that is not related to telecommunications services, e.g., corporate, governmental, or educational institution LANs, and the like.

In one example, the access network 120 may be in communication with one or more user endpoint devices 108 and 110. The access network 120 may transmit and receive communications between the user endpoint devices 108 and 110, between the user endpoint devices 108 and 110 and the server(s) 126, the AS 104, other components of the core network 102, devices reachable via the Internet in general, and so forth. Similarly, the access network 122 may be in communication with one or more user endpoint devices 112 and 114. The access network 122 may transmit and receive communications between the user endpoint devices 112 and 114, between the user endpoint devices 112 and 114 and the server(s) 126, the AS 104, other components of the core network 102, devices reachable via the Internet in general, and so forth.

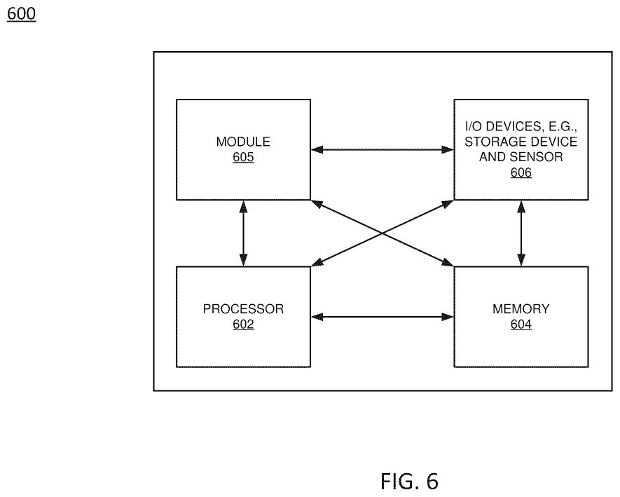

In one example, each of the user endpoint devices 108-114 may comprise any single device or combination of devices that may be used by a user to participate in a virtual collaboration session (e.g., a virtual conference call, a Web-based chat application, or the like). For example, any of the user endpoint devices 108-114 may comprise a mobile device, a cellular smart phone, a gaming console, a set top box, a laptop computer, a tablet computer, a desktop computer, an Internet of Things (IoT) device, a wearable smart device (e.g., a smart watch, a fitness tracker, a head mounted display, or Internet-connected glasses), an application server, a bank or cluster of such devices, and the like. To this end, the user endpoint devices 108-114 may comprise one or more physical devices, e.g., one or more computing systems or servers, such as computing system 600 depicted in FIG. 6, and may be configured as described below.

In one example, one or more servers 126 may be accessible to the user endpoint devices 108-114 via the Internet 124 in general. The server(s) 126 may operate in a manner similar to the AS 104, which is described in further detail below.

In accordance with the present disclosure, the AS 104 and DB 106 may be configured to provide one or more operations or functions in connection with examples of the present disclosure for automatically providing a back-up connection for a residential gateway, as described herein. To this end, the AS 104 may comprise one or more physical devices, e.g., one or more computing systems or servers, such as computing system 600 depicted in FIG. 6, and may be configured as described below.

In some examples, the AS 104 may comprise an Artificial Intelligence (AI) system that may be integrated with other AI systems (potentially located in a workspace of the user endpoint devices 108-114) into a single AI system. For example, the AI system may employ one or more machine learning algorithms (MLAs), e.g., one or more trained machine learning models (MLMs). For instance, a machine learning algorithm (MLA), or machine learning model (MLM) trained via a MLA may be used for detecting whether a wireline connection is lost and that a backup connection e.g., a VPN tunnel is to be established. Data for the training may comprise network data associated with previous network disruptions caused by a malfunctioning wireline connection to one or more subscribers, e.g., signaling data just prior to the loss of connectivity and the like. For instance, the MLA (or the trained MLM) may comprise a deep learning neural network, or deep neural network (DNN), such as convolutional neural network (CNN), a generative adversarial network (GAN), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on.

The AS 104 may have access to at least one database (DB) 106, where the DB 106 may store customer data/profiles associated with user endpoint devices 108-114, applications that can be downloaded and executed by the user endpoint devices 108-114 to automatically provide a back-up connection for a residential gateway, a list of authorized user endpoint devices 108-114 that can automatically provide a back-up connection for a residential gateway, an amount of data transmitted via a VPN tunnel (described below) between the user endpoint devices 108-114 and a residential gateway for assigning different priorities and/or alternative billing arrangements, and the like.

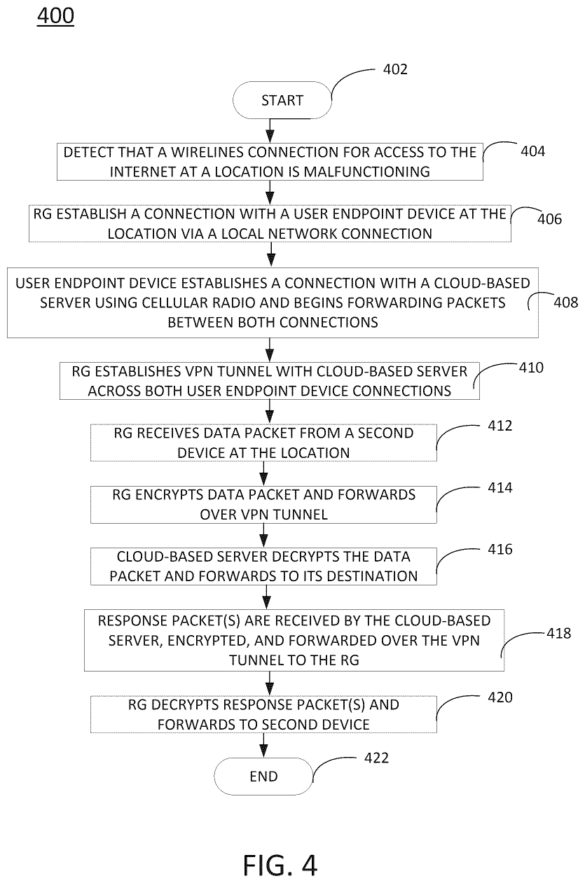

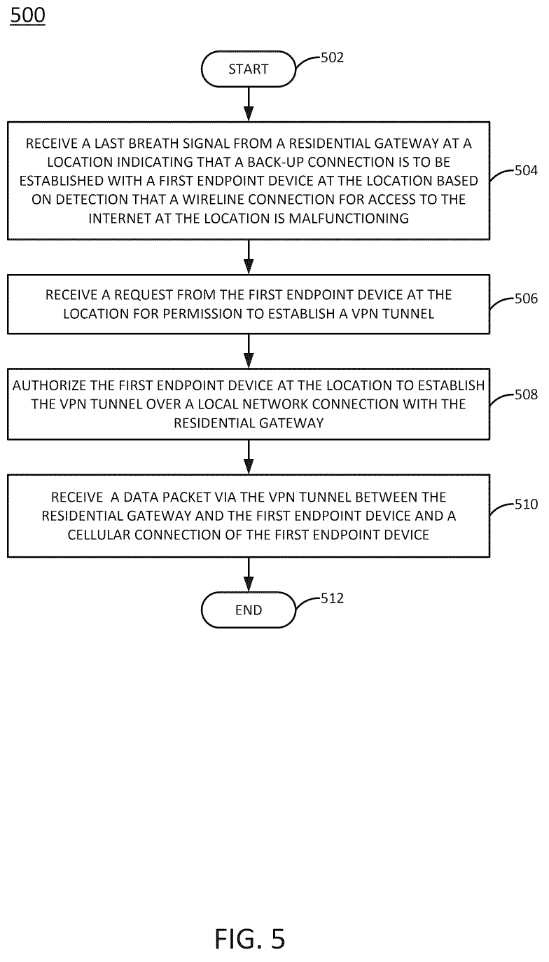

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for automatically providing a back-up connection for a residential gateway, as described herein. Example methods for automatically providing a back-up connection for a residential gateway are described in greater detail below in connection with FIGS. 4 and 5.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 6 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, media streaming server, a content distribution network (CDN) and the like. For example, portions of the core network 102, access networks 120 and 122, and/or Internet 124 may comprise a content distribution network (CDN) having ingest servers, edge servers, and the like. Similarly, although only two access networks 120 and 122 are shown, in other examples, the access networks 120 and 122 may comprise a plurality of different access networks that may interface with the core network 102 independently or in a chained manner. For example, user endpoint devices 108-114 may communicate with the core network 102 via different access networks. Thus, these and other modifications are all contemplated within the scope of the present disclosure.

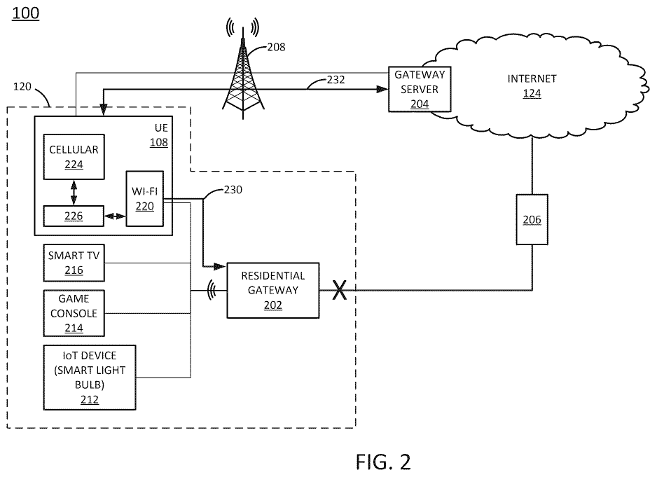

FIG. 2 illustrates an example portion of the network 100 illustrated in FIG. 1. For example, the portion of the network 100 may include the access network 120 at a location of a subscriber of the service provider. For example, the access network 120 may be a local network, such as Wi-Fi network (e.g., a local area network) at a home or a business of the subscriber. The access network 120 may include a residential gateway 202 that provides a wireline connection 206 via a communication network (e.g., one or more external access networks and/or core network of FIG. 1) to reach the Internet 124.

The subscriber may have a user endpoint device 108 as well as other devices 212 (e.g., a smart light bulb), 214 (e.g., a game console), and 216 (e.g., a smart TV) connected to the residential gateway 202 to access the Internet 124 over the wireline connection 206 (e.g., via an external wired network or a core network as shown in FIG. 1). The user endpoint device 108 and the other devices 212, 214, and 216 may be connected to the residential gateway 202 via the local network connection (e.g., via a wireless Wi-Fi connection).

In one embodiment, the user endpoint device 108 may be a mobile endpoint device (e.g., a mobile telephone or a smart phone). The user endpoint device 108 may include an application 226 that can be downloaded from the service provider network (e.g., from the DB 106 in the core network 102 illustrated in FIG. 1). The application 226 may be executed by the user endpoint device 108 to perform the functions to automatically provide a back-up connection for the residential gateway 202, as described herein.

The user endpoint device 108 may also include a Wi-Fi interface 220 and a cellular interface 224. The Wi-Fi interface 220 may establish a wireless communication with the residential gateway 202. The cellular interface 224 may establish a wireless cellular connection to the Internet 124 via a radio access point 208 (e.g., via a cellular network and a wired network or a core network). In one embodiment, the radio access point 208 may represent an access network and the network of the subscriber can be deemed a local area network of the subscriber including the residential gateway 202.

The radio access point 208 may be communicatively coupled to a gateway server 204 for a website hosted by a server 126 in the Internet 124 that one of the devices 212, 214, or 216 may be trying to access.

Although a single user endpoint device 108 is illustrated in FIG. 2, it should be noted that the location may include multiple user endpoint devices 108. As discussed in further details below, there may be multiple user endpoint devices 108 that include the application 226. Thus, if one user endpoint device 108 leaves, another user endpoint device 108 with the pre-configured application 226 may be detected and selected to provide the back-up connection for the residential gateway 202.

The devices 212, 214, and 216 may be any type of device. For example, the device 212 may be a smart device or an Internet of Things (IoT) device, such as a smart light bulb, a smart appliance, a home thermostat, a security system, a smart home system, and the like. The device 214 may be a gaming console or an entertainment console. The device 216 may be a smart television (TV). Although three additional devices 212, 214, and 216 are illustrated in FIG. 2, it should be noted that any number of devices may be deployed at the location associated with the access network 120.

In one embodiment, the UE 108 and the devices 212-216 may be connected wirelessly to the residential gateway 202 via Wi-Fi. The game console 214 may access the Internet 124 via the gateway server 204 to a gaming website (not shown). At some point in time, the wireline connection 206 may experience a malfunction. For example, the wireline connection 206 may be accidentally damaged, one or more components along the wireline connection 206 may be malfunctioning, the wireline connection 206 may be down due to scheduled maintenance, and the like.

When the residential gateway 202 detects that the wireline connection 206 is malfunctioning (e.g., unable to support a guaranteed quality of service (QoS), experiencing a significant loss of bandwidth, or experiencing a complete loss of bandwidth), the residential gateway 202 may send a “last breath” notification (broadly a notification signal) to the AS 104 in the core network 102 of the service provider. In response, the AS 104 may provide authorization to one or more user endpoint devices 108 at the location of the residential gateway 202 to provide a back-up connection to the residential gateway 202. The residential gateway 202 may also initiate a process to establish a back-up connection via at least one of the user endpoint devices 108.

In one embodiment, the residential gateway 202 may detect the user endpoint device 108 that has the application 226 via the local network connection. The residential gateway 202 may transmit a control signal to the user endpoint device 108 to execute the application 226. In response, the application 226 may establish a virtual private network (VPN) tunnel 230 between the user endpoint device 108 and the residential gateway 202. The VPN tunnel 230 may also include multiple legs. For example, the VPN tunnel 230 may also span a cellular connection 232 to the gateway server 204. In one embodiment, the application 226 may also transmit a request to the AS 104 via the cellular interface 224 to establish the VPN tunnel 230.

When the VPN tunnel 230 is established, the game console 214 may then transmit data packets to and receive data packets from the gateway server 204 via the VPN tunnel 230 and over the cellular connection 232. In one embodiment, the residential gateway 202 may encrypt the data packets from the game console 214 before transmitting the data packets over the VPN tunnel 230.

The user endpoint device 108 may then transmit the encrypted data packets over the cellular connection 232 to the gateway server 204 without inspecting or decrypting the encrypted data packets. As a result, any data being transmitted over the VPN tunnel 230 may remain secure and the user endpoint device 108 may not have access (e.g., decrypting access) to any data that are forwarded from the residential gateway 202 via the VPN tunnel 230.

In one embodiment, the AS 104 (shown in FIG. 1) may track an amount of data packets that are transmitted over the VPN tunnel 230. For example, the user endpoint device 108 may provide information to the AS 104 identifying which data packets are from the VPN 230. In another example, the data packets that are encrypted by the residential gateway 202 may be marked with an identifier. The data packets may be transmitted through the core network 102 on the way to the gateway server 204. The AS 104 may then monitor the data packets with the identifier to determine an amount of data packets transmitted over the VPN tunnel 230.

By tracking the data packets that are transmitted over the VPN tunnel 230, the AS 104 may treat these data packets differently from other data packets (e.g., data packets that originated from or transmitted to the user endpoint device 108, e.g., a cellular call initiated from or directed to the user endpoint device 108). For example, the back-up connection may be a service that is assessed additional charges. The data packets that are transmitted over the VPN tunnel 230 may be billed as an alternate charge. For example, the subscriber may have an unlimited data plan. However, data that is transmitted over the VPN tunnel 230 may be charged per megabyte or any other delineations and excluded from the unlimited data plan.

In one embodiment, data packets that are transmitted over the VPN tunnel 230 may be assigned a different priority over other data packets. For example, the data packets that are transmitted over the VPN tunnel 230 may be throttled to reduce congestion over the cellular network, or may be given a lower priority such that if there is congestion on the cellular network the data packets that are transmitted over the VPN tunnel 230 may be delayed before other data packets. In another example, the subscriber may pay additional fees to give the data packets transmitted over the VPN tunnel 230 a higher priority over other data packets.

As noted above, the location may include multiple user endpoint devices 108. For example, the location may include a family of four and each family member may have a user endpoint device 108. The user endpoint devices 108 may be assigned a priority for providing back-up services that may be stored in a user profile in the DB 106. Each user endpoint device 108 associated with each family member may have previously downloaded the application 226.

A first user endpoint device 108 associated with a first family member may be assigned a highest priority. As a result, when the wireline connection 206 is deemed to be malfunctioning, the application 226 on the first user endpoint device 108 may be executed to establish the back-up connection for the residential gateway 202.

However, at a later time, the first family member may leave the location with the first user endpoint device 108. The residential gateway 202 may detect that the first user endpoint device 108 is no longer within range (e.g., no longer within a defined range of the location of the residential gateway 202). As a result, the residential gateway 202 may detect the other three user endpoint devices 108 at the location. In one embodiment, each remaining user endpoint device 108 may request permission from the AS 104 to establish the back-up connection. The AS 104 may grant permission to the user endpoint device with the next highest priority based on the assigned priorities in the user profile stored in the DB 106.

For example, a second user endpoint device 108 associated with a second family member may have the second highest priority. As a result, the second user endpoint device 108 may execute the application 226 to re-establish the VPN tunnel 230 with the residential gateway 202.

In one embodiment, when the first user endpoint device 108 returns, the residential gateway 202 may automatically switch the VPN tunnel 230 back to the first user endpoint device 108 from the second user endpoint device 108. In another embodiment, the VPN tunnel 230 may remain with the second user endpoint device 108 even if the first user endpoint device 108 returns to the location.

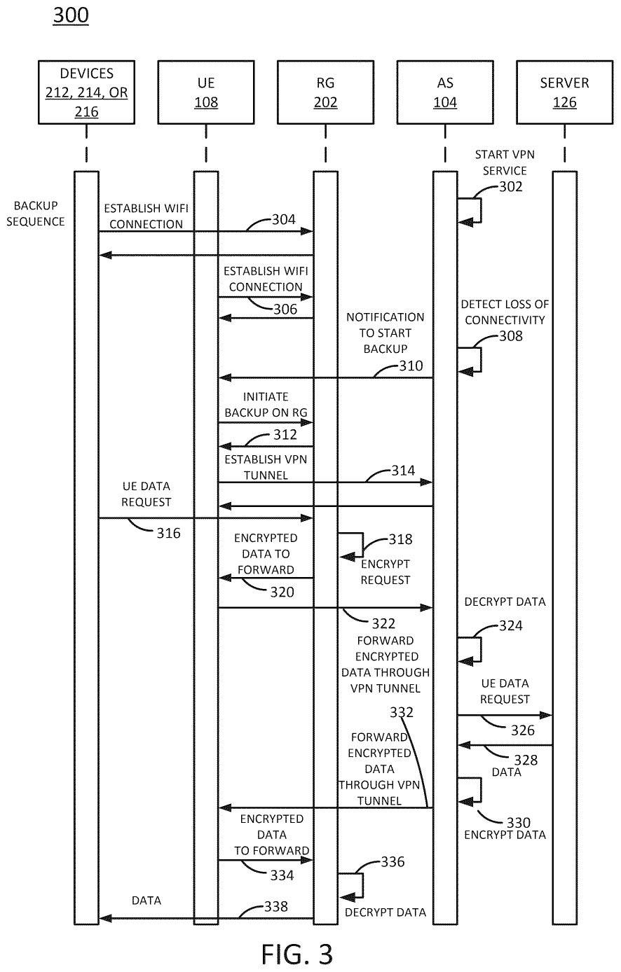

FIG. 3 illustrates an example timing diagram of a method 300 of the present disclosure. FIG. 3 illustrates the timing between devices 212, 214 or 216, the UE 108, the RG 202, the AS 104, and the server 126. In one embodiment, a subscriber may subscribe to one or more services of VPN servers at step 302 with the AS 104.

At step 304, the devices 212, 214, and 216 may establish a Wi-Fi connection with the RG 202. At step 306, the UE 108 may establish a Wi-Fi connection with the RG 202.

At step 308, the AS 104 may determine that there is a loss of connectivity. For example, the wireline connection to the RG 202 may be malfunctioning. In one embodiment, the RG 202 may detect the loss of connectivity and send a “last breath” notification to the AS 104.

At step 310, the AS 104 may notify the UE 108 to start the process to establish a back-up connection. As an example, the UE 108 may execute the application 226. At step 312, the UE 108 may initiate a back-up connection to the RG 202 via a local network connection, such as Wi-Fi.

At step 314, a VPN tunnel may be established between the UE 108, the RG 202, and the AS 104. At step 316, one of the devices 212, 214, or 216 may request data (e.g., video data, audio data, multimedia data, etc.). The request may be received via the RG 202 over the local network connection.

At step 318, the RG 202 may encrypt the request. The encrypted request may be transmitted to the UE 108 over the VPN tunnel at step 320. At step 322, the UE 108 may transmit the encrypted request to the AS 104 over the VPN tunnel.

At step 324, the AS 104 may decrypt the encrypted request. The AS 104 may send the request to the server 126 for the data at step 326. At step 328, the AS 104 may receive the data from the server 126. At step 330, the AS 104 may encrypt the data. At step 332, the AS 104 may transmit the encrypted data to the UE 108 via the VPN tunnel.

At step 334, the UE 108 may transmit the encrypted data to the RG 202 via the VPN tunnel. Notably, the UE 108 does not decrypt any data, nor does the UE 108 inspect any of the data. The UE 108 simply acts as a conduit for which data can be transmitted while the wireline connection is malfunctioning.

At step 336, the RG 202 decrypts the encrypted data. At step 338, the RG 202 forwards the decrypted data to the device 212, 214, or 216 that requested the data.

FIG. 4 illustrates a flowchart of an example method 400 for automatically providing a back-up connection for a residential gateway, in accordance with the present disclosure. In one example, steps, functions and/or operations of the method 400 may be performed by a device as illustrated in FIG. 2, e.g., RG 202 or any one or more components thereof. In another example, the steps, functions, or operations of method 400 may be performed by a computing device or system 600, and/or a processing system 602 as described in connection with FIG. 6 below. For instance, the computing device 600 may represent at least a portion of the RG 202 in accordance with the present disclosure. For illustrative purposes, the method 400 is described in greater detail below in connection with an example performed by a processing system, such as processing system 402.

The method 400 begins in step 402 and proceeds to step 404. In step 404, the processor may detect that a wireline connection for access to the Internet at a location is malfunctioning. For example, the wireline connection may be malfunctioning due to a cut in the communication line, a device along the wireline connection that is malfunctioning, a scheduled maintenance, and the like.

In one embodiment, the processor of the RG 202 may transmit a “last breath” notification to the service provider core network to indicate that the wireline connection is malfunctioning. Alternatively, the service provider core network may detect the wireline connection is malfunctioning on its own, e.g., losing a periodic heart beat signal from the RG 202. The service provider may then notify a user endpoint device (e.g., a first user endpoint device) to execute an application to establish a back-up connection to the RG 202.

In step 406, the processor of the RG may establish a virtual private network (VPN) tunnel with the user endpoint device at the location via a local network connection. For example, the user endpoint device may execute a pre-configured application to establish the VPN tunnel.

In step 408, the user endpoint device may establish a connection with a cloud-based server using a cellular radio and may begin forwarding packets between both connections, e.g., the connection with the cloud-based server and the virtual private network (VPN) tunnel.

In step 410, the processor of the RG may establish a VPN tunnel with the cloud-based server across both of the user endpoint connections, e.g., the connection of the endpoint device with the cloud-based server and the virtual private network (VPN) tunnel of the endpoint device with the RG.

In step 412, the processor of the RG may receive a data packet (e.g., one or more data packets) from a second device (e.g., a second user endpoint device) at the location. For example, the second device may be a smart appliance, a gaming console, a smart TV, and the like. The data packet may be a request for data, multi-media data packet (e.g., video, images, audio, and the like), or any other type of data.

In step 414, the processor of the RG may encrypt the data packet received from the second device. For example, the RG 202 may encrypt the data packet before the data packet is transmitted over the VPN tunnel. The data packet may be encrypted using any available encryption method. However, the type of encryption may not be shared with the first endpoint device. As a result, the first endpoint device may not have the ability to decrypt the data packet. Thus, the encrypted data packets may be forwarded by the first endpoint device over the VPN tunnel without decrypting the data packet or inspecting the data packet.

In step 416, the cloud-based server may decrypt the data packet of the second device and forward the decrypted packet to its destination.

In step 418, response packets destined for the second device are received by the cloud-based server. In turn, the cloud-based server may encrypt the response packets and forward the encrypted response packets over the VPN tunnel to the RG.

In step 420, the processor of the RG may decrypt the response packets and forward the decrypted response packets to the second device. The method 400 may end in step 422.

FIG. 5 illustrates a flowchart of an example method 500 for automatically providing a back-up connection for a residential gateway, in accordance with the present disclosure. In one example, steps, functions and/or operations of the method 500 may be performed by a device as illustrated in FIG. 1, e.g., AS 104 or any one or more components thereof. In another example, the steps, functions, or operations of method 500 may be performed by a computing device or system 600, and/or a processing system 602 as described in connection with FIG. 6 below. For instance, the computing device 600 may represent at least a portion of the AS 104 in accordance with the present disclosure. For illustrative purposes, the method 500 is described in greater detail below in connection with an example performed by a processing system, such as processing system 602.

The method 500 begins in step 502 and proceeds to step 504. In step 504, the processor may receive a last breath signal (broadly a signal) from a residential gateway at a location indicating that a back-up connection is to be established with a user endpoint device at the location based on a detection that a wireline connection for access to the Internet at the location is malfunctioning. For example, the wireline connection may malfunction due to a cut in the line, a device along the wireline connection that is malfunctioning, a scheduled maintenance, and the like.

In step 506, the processor may receive a request from a first endpoint device (e.g., a first user endpoint device) at the location for permission to establish a virtual private network (VPN) tunnel. For example, a subscriber may have subscribed to one or more services to allow the setup of a back-up connection to the RG via a cellular network in response to a triggering event, e.g., a service interruption over a wireline connection. The service provider may store permissions in a user profile stored in a DB in the core network for the service provider.

In step 508, the processor may authorize the first endpoint device at the location to establish the VPN over a local network connection with the residential gateway. If the first endpoint device associated with the subscriber is authorized, the service provider may provide a notification to the first endpoint device that the first endpoint device is authorized. In response, the first endpoint device may execute an application to establish a VPN tunnel with the RG. It should be noted that in one embodiment, the establishment of the VPN tunnel is performed automatically and seamlessly without receiving an input from a user of the first endpoint device. In other words, the RG may interact directly with a pre-configured application of the first endpoint device to establish the VPN tunnel without having the user of the first endpoint device performing any specific actions to establish the VPN tunnel. However, the first endpoint device may show on its display an indication (e.g., “Serving as Backup Connection”) that the first endpoint device is currently serving the role of a backup connection to the RG since its performance may be impacted.

In step 510, the processor may receive a data packet via the VPN tunnel between the residential gateway and the first endpoint device and a cellular connection of the first endpoint device. In one embodiment, the data packet may be encrypted by the RG such that the first endpoint device cannot decrypt or inspect the encrypted data packet. The processor may decrypt the encrypted data packet before forwarding the data packet to the intended destination (e.g., a website). The processor may also encrypt data packets addressed to a receiving endpoint device (e.g., a second user endpoint device) that is to be transmitted over the VPN tunnel. The RG may then decrypt the data packet and forward the decrypted data packet to the receiving endpoint device.

In one embodiment, the data packets that are transmitted over the VPN tunnel may also be tracked by the service provider. As a result, the data packets may be treated differently from other data packets. For example, the data packets transmitted over the VPN tunnel may be charged on a per megabyte rate rather than being included as part of an unlimited data plan associated with the first endpoint device. In another example, the data packets transmitted over the VPN tunnel may be assigned a different priority. For example, the data packets transmitted over the VPN tunnel may be given a lower priority compared to other data packets. As a result, if congestion is detected on the cellular network, the data packets transmitted over the VPN tunnel may be held back or transmitted after all of the other data is transmitted successfully. The method 500 may end in step 512.

It should be noted that the methods 400 and 500 may be expanded to include additional steps or may be modified to include additional operations, parameters, or scores with respect to the steps outlined above. In addition, although not specifically specified, one or more steps, functions, or operations of the methods 400 and 500 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIGS. 4 and 5 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 6 depicts a high-level block diagram of a computing device or processing system specifically programmed to perform the functions described herein. As depicted in FIG. 6, the processing system 600 comprises one or more hardware processor elements 602 (e.g., a central processing unit (CPU), a microprocessor, or a multi-core processor), a memory 604 (e.g., random access memory (RAM) and/or read only memory (ROM)), a module 605 for automatically providing a back-up connection for a residential gateway, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the methods 400 and 500 as discussed above are implemented in a distributed or parallel manner for a particular illustrative example, i.e., the steps of the above methods 400 and 500 or the entire methods 400 and 500 are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 602 can also be configured or programmed to cause other devices to perform one or more operations as discussed above. In other words, the hardware processor 602 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed methods 400 and 500. In one example, instructions and data for the present module or process 605 for automatically providing a back-up connection for a residential gateway (e.g., a software program comprising computer-executable instructions) can be loaded into memory 604 and executed by hardware processor element 602 to implement the steps, functions, or operations as discussed above in connection with the illustrative methods 400 and 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 605 for automatically providing a back-up connection for a residential gateway (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, via a processor of a residential gateway, that a wireline connection for access to a communication network at a location is malfunctioning;
establishing, via the processor, a virtual private network tunnel with a first endpoint device at the location via a local network connection;
receiving, via the processor, a data packet from a second endpoint device at the location;
encrypting, via the processor, the data packet; and
transmitting, via the processor, the data packet that is encrypted over the virtual private network tunnel to the first endpoint device, wherein the first endpoint device is to transmit the data packet that is encrypted to a destination over a cellular connection of the first endpoint device.

2. The method of claim 1, further comprising:
notifying, via the processor, a service provider of the communication network with a notification signal that a back-up connection is to be established to allow the service provider to determine if the first endpoint device is authorized to provide the virtual private network tunnel.

3. The method of claim 1, further comprising:
notifying, via the processor, a service provider of the communication network with a notification signal that a back-up connection is to be established to allow the service provider to track an amount of data transmitted via the virtual private network tunnel.

4. The method of claim 1, further comprising:
notifying, via the processor, a service provider of the communication network with a notification signal that a back-up connection is to be established to allow the service provider to apply a different priority to the data packet transmitted over the virtual private network tunnel compared to other cellular data traffic originating from the first endpoint device.

5. The method of claim 1, further comprising:
detecting, via the processor, that the first endpoint device is no longer within a defined range of the location;
determining, via the processor, a third endpoint device that is authorized to establish the virtual private network tunnel; and
establishing, via the processor, the virtual private network tunnel with the third endpoint device.

6. The method of claim 1, wherein the local network connection is a wi-fi connection.

7. The method of claim 1, wherein the first endpoint device executes an application provided by a service provider of the communication network to establish the virtual private network tunnel.

8. The method of claim 1, wherein the detecting is performed by a machine learning model implemented on the residential gateway.

9. The method of claim 1, wherein the establishing the virtual private network tunnel with the first endpoint device at the location via the local network connection is performed without receiving an input from a user of the first endpoint device.

10. An apparatus comprising:
a processor of a residential gateway; and
a non-transitory computer readable medium storing instructions, which when executed by the processor, cause the processor to perform operations, the operations comprising:
detecting that a wireline connection for access to a communication network at a location is malfunctioning;
establishing a virtual private network tunnel with a first endpoint device at the location via a local network connection;
receiving a data packet from a second endpoint device at the location;
encrypting the data packet; and
transmitting the data packet that is encrypted over the virtual private network tunnel to the first endpoint device, wherein the first endpoint device is to transmit the data packet that is encrypted to a destination over a cellular connection of the first endpoint device.

11. The apparatus of claim 10, the operations further comprising:
notifying a service provider of the communication network with a notification signal that a back-up connection is to be established to allow the service provider to determine if the first endpoint device is authorized to provide the virtual private network tunnel.

12. The apparatus of claim 10, the operations further comprising:
notifying a service provider of the communication network with a notification signal that a back-up connection is to be established to allow the service provider to track an amount of data transmitted via the virtual private network tunnel.

13. The apparatus of claim 10, the operations further comprising:
notifying a service provider of the communication network with a notification signal that a back-up connection is to be established to allow the service provider to apply a different priority to the data packet transmitted over the virtual private network tunnel compared to other cellular data traffic originating from the first endpoint device.

14. The apparatus of claim 10, the operations further comprising:
detecting that the first endpoint device is no longer within a defined range of the location;
determining a third endpoint device that is authorized to establish the virtual private network tunnel; and
establishing the virtual private network tunnel with the third endpoint device.

15. A method comprising:
receiving, via a processor of an application server of a service provider network, a notification signal from a residential gateway at a location indicating that a back-up connection is to be established with a first endpoint device at the location based on a detection that a wireline connection for access to the service provider network at the location is malfunctioning;
receiving, via the processor, a request from the first endpoint device at the location to establish a virtual private network tunnel;
authorizing, via the processor, the first endpoint device at the location to establish the virtual private network over a local network connection with the residential gateway; and
receiving, via the processor, a data packet via the virtual private network tunnel between the residential gateway and the first endpoint device and a cellular connection of the first endpoint device.

16. The method of claim 15, wherein the data packet is encrypted by the residential gateway and transmitted by the first endpoint device without the first endpoint device decrypting the data packet.

17. The method of claim 15, wherein an amount of data transmitted by the first endpoint device from the virtual private network tunnel is tracked by the application server of the service provider network.

18. The method of claim 17, wherein the amount of data is billed as an alternate charge.

19. The method of claim 15, wherein the data packet transmitted by the first endpoint device from the virtual private network tunnel is assigned a different priority than other data originating from the first endpoint device that is transmitted over the cellular connection.

20. The method of claim 15, further comprising:
providing, via the processor, an application for providing the back-up connection to the first endpoint device prior to the receiving the notification signal from the residential gateway.
